(19) United States
(12) Patent Application Publication
(10) Pub. No.: US 2004/0234138 A1
(43) Pub. Date: Nov. 25, 2004

(54) METHOD FOR GENERATING A USER'S FAVORITE LOGO OF AN IMAGE DISPLAY SYSTEM

(76) Inventor: Hua-Chun Hsieh, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/709,662

(22) Filed: May 21, 2004

(30) Foreign Application Priority Data
May 23, 2003 (TW) 092114007

(51) Int. Cl. G06K 9/36

(52) U.S. Cl. 382/232

(57) ABSTRACT

A method for generating a user's favorite logo of an image display system includes the following steps: (a) providing a plurality of images in the image display system, (b) selecting an image from the plurality of images, (c) encoding the selected image, (d) storing the encoded image in a memory, (e) retrieving the encoded image from the memory when restarting the display system, (f) decoding the encoded image, (g) and displaying the decoded image on the display system.

### BACKGROUND OF INVENTION

1. Field of the Invention

The present invention relates to a method for generating a user's favorite logo, and more specifically, to a method for generating a user's favorite logo of an image display system.

2. Description of the Prior Art

Please refer to FIG. 1. FIG. 1 is a block diagram of a prior art image display device 10. The image display device 10 includes a decoder 12 for decoding an image data, a temporary memory 13 for storing a decoded image data outputted from the decoder 12 and waiting to be displayed on the image display device 10, an encoder 14 for encoding an image data, and a flash memory 16 for storing a program code and an encoded image data generated from the encoder 14.

Please refer to the FIG. 2. FIG. 2 is a flowchart of how the prior art image display device 10 shown in FIG. 1 generates a user's favorite logo. The flow includes following steps:

Step 100: Capture an image data from a dynamic image file 18 processed on the image display device 10;

Step 102: Encode the image data captured from the image display device 10 for generating an encoded image data;

Step 104: Store the encoded image data in the flash memory 16;

Step 106: Read the encoded image data from the flash memory 16 when the image display device 10 is restarted;

Step 108: Decode the encoded image data for generating a decoded image data; and

Step 110: Display the decoded image data on the image display device 10.

In step 100, when a dynamic image file 18 is displayed on the image display device 10, a decoder 12 decodes a plurality of image data included in the dynamic image file 18 according to the program code stored in the flash memory 16 for generating corresponding a plurality of decoded image data. The decoded image data are temporarily stored in a temporary memory 13 and then displayed on the image display device 10.

In step 102, when the image display device 10 receives an image-capture control signal, the image display device 10 captures an image data from the temporary memory 13. Then the encoder 14 encodes this captured image data according to the program code stored in the flash memory 16 to generate an updated image data also referred to as an encoded image data.

In step 104, before storing the encoded image data, whether the remaining space on the flash memory 16 is large enough to store the encoded image data is checked first. If the remaining space on the flash memory 16 is not enough to store the encoded image data, step 104 is stopped and step 102 is performed (at the point, the parameters of the encoder 14 are reconfigured to generate a more compressed encoded image data) to generate another encoded image data. Afterwards, step 104 is performed to check whether the space on the flash memory 16 is large enough. As a result, a loop from step 104 to step 102 is created, the loop being sustained as long as it is determined the remaining space is not large enough. If the remaining space of the flash memory 16 is large enough to store the encoded image data, the empty clusters of the flash memory 16 are rearranged to form a single, continuous, empty section in the flash memory 16 where the updated image data is stored.

From step 106 to step 110, when the image display device 10 is restarted, the encoded image data previously stored in the flash memory 16 is read. The decoder 12 is used for decoding the encoded image data to generate a corresponding decoded image data, and the decoded image data is displayed on the image display device 10.

In the prior art method of generating a user's favorite logo for the image display device 10, a user can use the image display device 10 to select a captured image to be used as an image data for generating a user's favorite logo. However, the image display device 10 cannot provide the user with a plurality of image data from which a user can select a desired one for generating the user's favorite logo.

On another note, distortion is introduced into the encoded image data when the image data is encoded. Additionally, the fact that the image display device 10 does not detect the display parameters or the disc data indicates that the decoded image data is not necessarily the very scene that the user wishes to capture by the image display device 10.

### SUMMARY OF INVENTION

It is therefore an objective of the present invention to provide a method for generating a user's favorite logo of an image display device to solve the above-mentioned problems.

According to an embodiment of the present invention, a method for generating a user's favorite logo of an image display device is presented. The method comprises (a) providing a plurality of image data on the image display device; (b) selecting an image data from the plurality of image data; (c) encoding the image data selected from the plurality of image data; (d) storing the encoded image data in a first memory; (e) decoding the encoded image data from the first memory when the image display device is restarted or a user's favorite logo display is desired; (f) decoding the encoded image data; and (g) displaying the decoded image data on the image display device.

According to another embodiment of the present invention, a method for generating a user's favorite logo of an image display device is presented. The method comprises (a) detecting whether a reference image data on the image display device is captured from a dynamic image file; (b) providing a plurality of image data from the dynamic image file according to the reference image data and then selecting an image data from the plurality of the image data when the reference image data on the image display device is captured from the dynamic image file wherein the reference image data of step (a) is selected; (c) encoding the selected image data of step (b); (d) storing the encoded image data in a first memory; (e) decoding the encoded image data from the first memory when the image display device is restarted; (f) decoding the encoded image data after performing step (e); and (g) displaying the decoded image data on the image display device.

### BRIEF DESCRIPTION OF DRAWINGS

FIG. 1 is a block diagram of a prior art image display device.

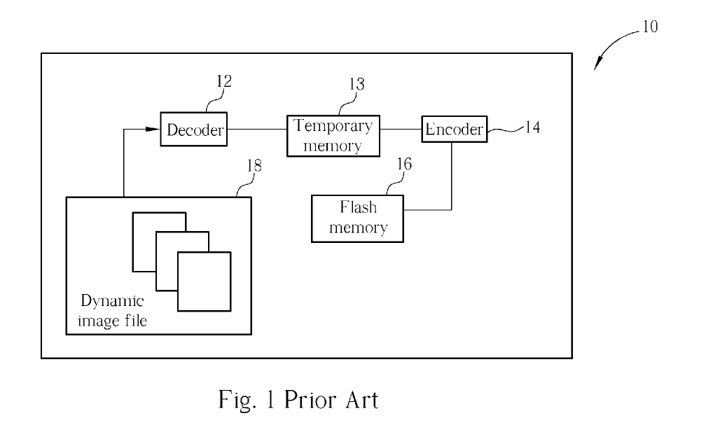

FIG. 2 is a flowchart of how the prior art image display device shown in FIG. 1 generates a user's favorite logo.

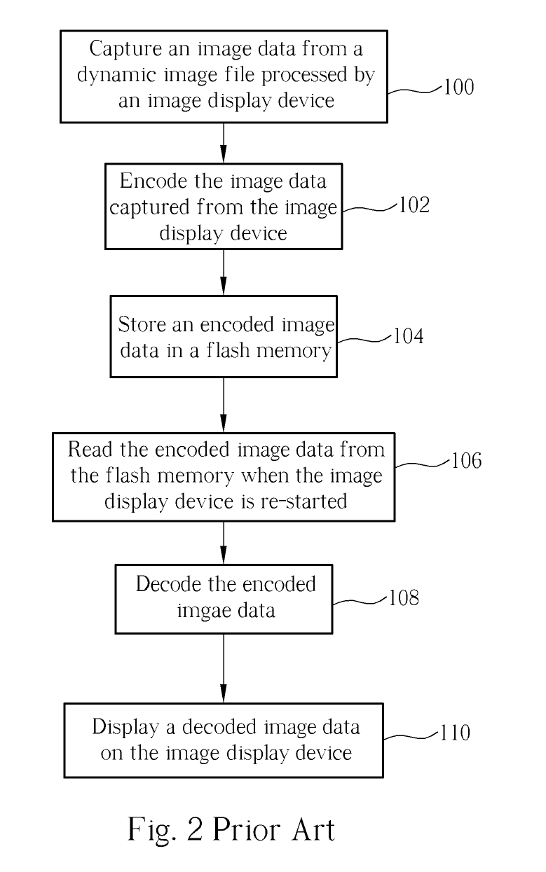

FIG. 3 is a block diagram of the image display device according to one embodiment of the present invention.

FIG. 4 is the first stage of a flowchart of a method for generating a user's favorite logo of an image display device of the first embodiment in the invention.

FIG. 5 is the second stage of the flowchart of a method for generating a user's favorite logo of an image display device of the first embodiment in the invention.

FIG. 6 is the third stage of the flowchart of a method for generating a user's favorite logo of an image display device of the first embodiment in the invention.

FIG. 7 is the fourth stage of the flowchart of a method for generating a user's favorite logo of an image display device of the first embodiment in the invention.

FIG. 8 is the first stage of a flowchart of a method for generating a user's favorite logo of an image display device of the second embodiment in the invention.

FIG. 9 is the second stage of the flowchart of a method for generating a user's favorite logo of an image display device of the second embodiment in the invention.

FIG. 10 is the third stage of the flowchart of a method for generating a user's favorite logo of an image display device of the second embodiment in the invention.

FIG. 11 is the fourth stage of the flowchart of a method for generating a user's favorite logo of an image display device of the second embodiment in the invention.

FIG. 12 is the image data and the miscellaneous data displayed on the image display device.

### DETAILED DESCRIPTION

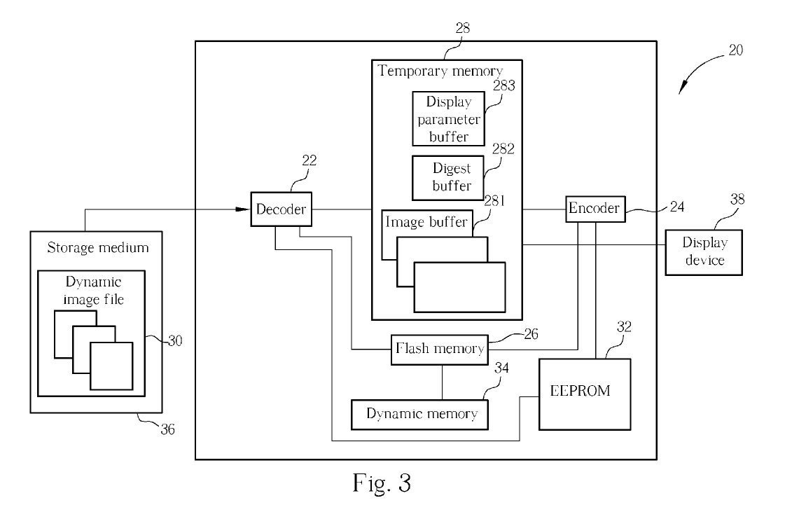

Please refer to FIG. 3. FIG. 3 is a block diagram of an image display device 20 according to the present invention. The image display device 20 comprises a decoder 22 for decoding image data stored in a storage medium 36 (for example, an optical disc), an encoder 24 for encoding image data, a flash memory 26 for storing a program code (ex, the program code for operating the image display device 20) and an encoded image data (for example, a user's favorite logo), a temporary memory 28 having a plurality of image buffers a frame buffer 281 for temporarily storing a plurality of image data when either a static image data or a dynamic image data is displayed on the image display device 20 (for example, when the image display device 20 displays the dynamic image data including a plurality of pictures, the image buffers 281 are used for storing both reference pictures (for example, I picture or P picture) and non-reference pictures (for example, B picture), a digest buffer 282 for temporarily storing information waiting to be transmitted to a display circuit (not shown), a display parameters buffer 283 for temporarily storing the display parameters related to the image data (ex: the zoom factor, the color or brightness settings, etc.) and the miscellaneous data read from the storage medium 36 (for example, the album ID, title, track, file name, etc.) an electrically erasable programmable read only memory (EEPROM)) for storing the display parameters and the image data of the storage medium 36, and a dynamic memory 34 for temporarily storing both the existing encoded image data and encoded image data read from the flash memory 26.

In this preferred embodiment, the flash memory 26 and the EEPROM 32 can be substituted with various kinds of non-volatile memory devices. Also, the two memories can be implemented in a single memory device but located at different addresses. Similarly, the temporary memory 28 and the dynamic memory 34 of the preferred embodiment can be substituted with various kinds of memory devices. A good choice for the temporary memory 28 and the dynamic memory 34 is to use a volatile memory, but a nonvolatile memory can also be used. The temporary memory 28 and the dynamic memory 34 also can be implemented in a single memory device but located at different addresses.

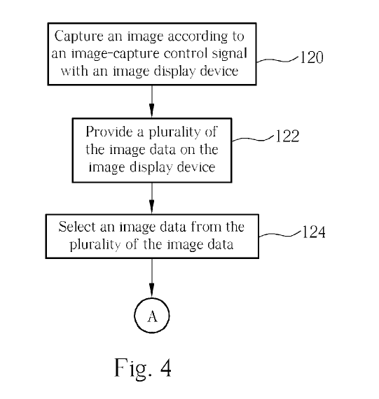

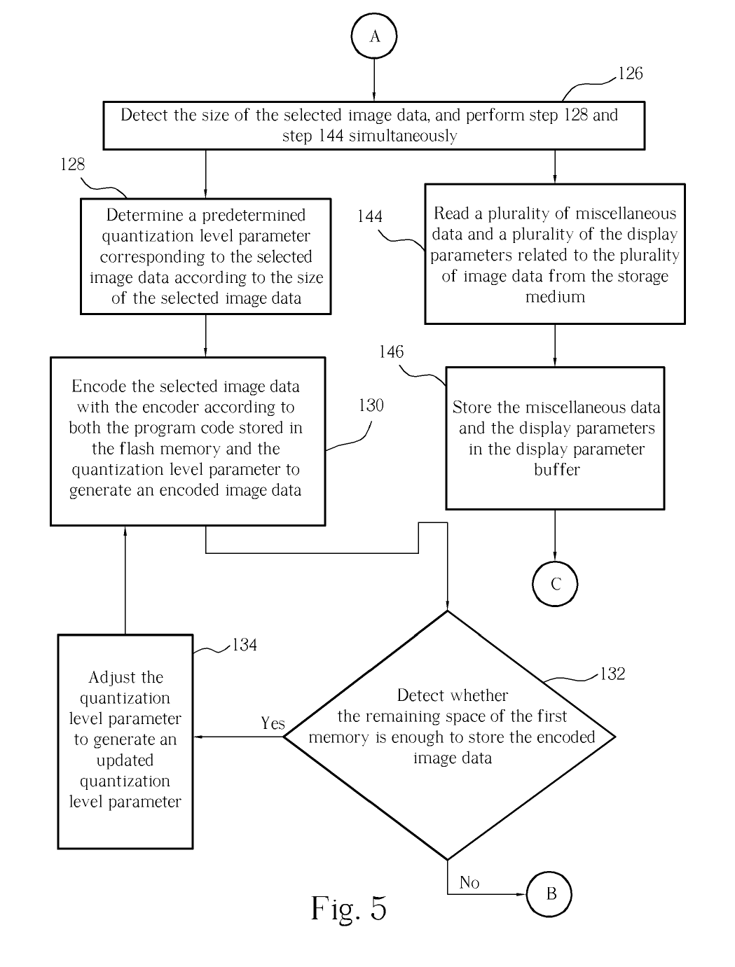

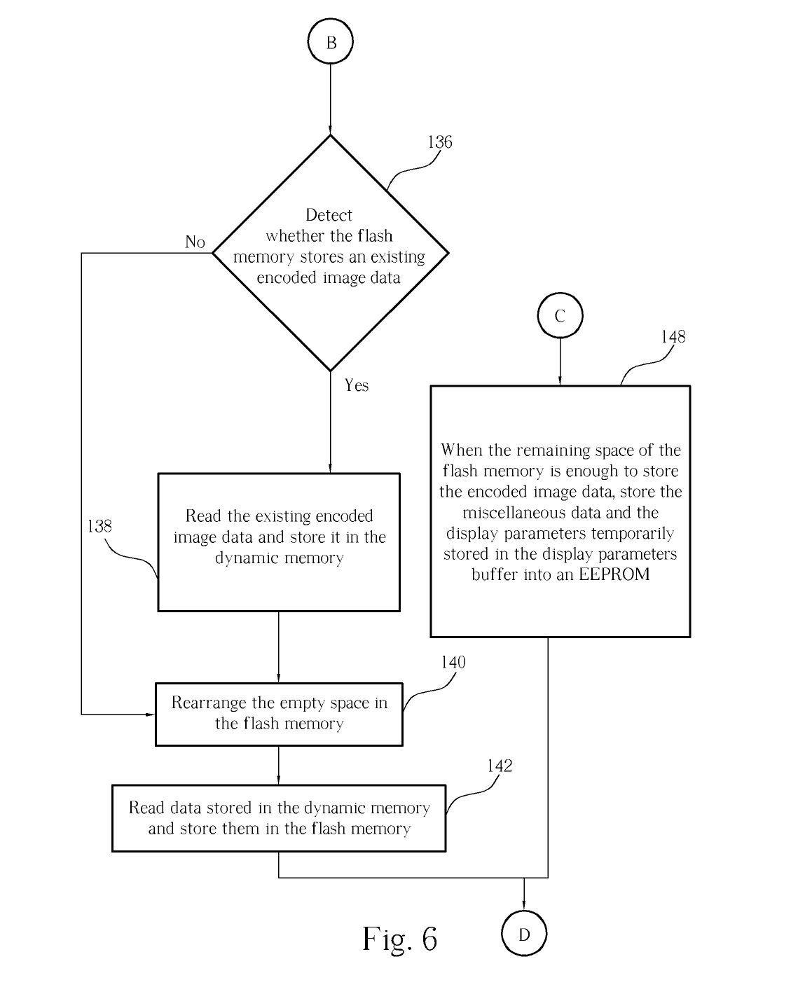

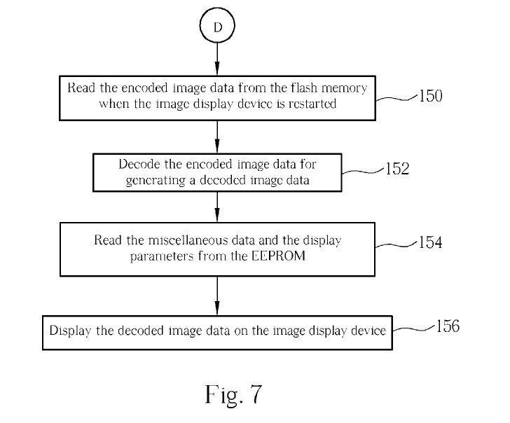

Please refer to FIG. 4-7. FIG. 4-7 respectively illustrates the first, second, third, and fourth stage of a flowchart of a method for generating a user's favorite logo of an image display device according to the first embodiment. The symbol A is used for connecting FIG. 4 and FIG. 5. The symbol B and the symbol C are used for connecting FIG. 5 and FIG. 6. The symbol D is used for connecting FIG. 6 and FIG. 7. The method for generating the user's favorite logo of the image display device 20 comprises the following steps:

Step 120: Capture an image according to an image-capture control signal with the image display device 20;

Step 122: Provide a plurality of image data on the image display device 20;

Step 124: Select an image data from the plurality of the image data;

Step 126: Detect the size of the selected image data, and performing step 128 and step 144 at the same time;

Step 128: Determine a predetermined quantization level parameter corresponding to the selected image data according to the size of the selected image data;

Step 130: Encode the selected image data with the encoder 24 according to both the program code stored in the flash memory 26 and the quantization level parameter to generate an encoded image data;

Step 132: Detect whether the remaining space of the first memory is large enough to store the encoded image data. If the remaining space of the first memory is enough to store the encoded image data, go to step 134; otherwise, go to step 136;

Step 134: Adjust the quantization level parameter to generate an updated quantization level parameter and then go to step 130;

Step 136: Detect whether the flash memory 26 stores an existing encoded image data. If the flash memory 26 stores an existing encoded image data, go to step 138; otherwise, go to step 140;

Step 138: Read the existing encoded image data stored in the flash 26 and store it in the dynamic memory 34;

Step 140: Rearrange the empty space in the flash memory 26;

Step 142: Read data (the encoded image data only or the encoded image data in conjunction with the existing encoded image data) stored in the dynamic memory 34 and store them back into the flash memory 26;

Step 144: Read a plurality of miscellaneous data and a plurality of display parameters related to the plurality of image data from the storage medium 36 storing the plurality of image data;

Step 146: Store the miscellaneous data and the display parameters into the display parameter buffer 283;

Step 148: When the remaining space of the flash memory 26 is large enough to store the encoded image data, store the miscellaneous data and the display parameters temporarily stored in the display parameters buffer 283 into the EEPROM 32;

Step 150: Read the encoded image data from the flash memory 26 when the image display device 20 is restarted;

Step 152: Decode the encoded image data for generating a decoded image data;

Step 154: Read the miscellaneous data and the display parameters from the EEPROM 32; and

Step 156: Display the decoded image data on the image display device 20.

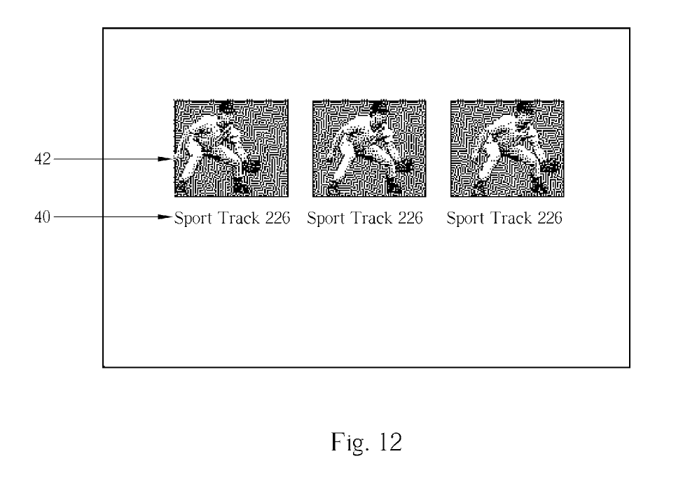

In steps 120-124, an image display device 20 displays a dynamic image file 30 (ex: a movie file complying with an MPEG I or MPEG II standard) stored in the storage medium 36. When the image display device 20 receives an image-capture control signal (ex: the user activates the image-capture function supported by the image display device 20), the plurality of image data temporarily stored in the frame buffer 281 and the miscellaneous data and display parameters temporarily stored in the display parameters buffer 283 are read. The information is then output to the display device 38 through the digest buffer 282, causing the picture shown in FIG. 12 to be displayed on the display device 38.

When the image display device 20 receives a selection signal (ex: the user selects a desired image data from the plurality of image data through the selection knob positioned on the image display device 20 and pushes a button to make a decision), the image display device 20 selects the chosen image data along with its corresponding display parameters and miscellaneous data. When the image display device 20 displays the dynamic image file 30, the related image data (ex: the Reference Pictures and B Pictures corresponding to the displayed image data according to the MPEG specification) and the display parameters corresponding to the displayed image data are stored in the temporary memory 28. Steps 120-124 are used for displaying and selecting the image data and display parameters currently stored in the temporary memory 28, and will not consume lots of system resources.

In steps 126-128, the image display device 20 detects the size of the image data, reads the miscellaneous data of the storage medium 36 and the display parameters of the image data, and determines a quantization level parameter according to the size of the image data. However, in the end, the image display device 20 will store the image data, the display parameters of the image data, and the miscellaneous data of the storage medium 36 into the EEPROM 32.

Please note that the quantization level parameter determines the quality and size of the encoded image data. The display parameters determine how the image data is displayed. For example, when the user enjoys the static image data (ex: JPEG or TIFF image data) or dynamic image data (ex: a movie file encoded according to the MPEG I or MPEG II standard and stored on the storage medium 36), the user can select to zoom in, zoom out, adjust the color or brightness, or have the image displayed in difference aspect ratio of 16:9, 4:3 letter box or 4:3 pan scan.

Therefore, the display parameters are used to determine how the image data is displayed and what the user sees right before his eyes at that moment. The prior art image display device does not store these display parameters, meaning that the user cannot store what he's currently seeing (ex: an image that is zoomed in 9 times with its brightness level raised by 30%). In this embodiment, the image display device 20 stores not only the image data itself, but also the display parameters corresponding to the image data so that the user can achieve the goal of “What You See Is What You Get”.

The storage medium 36 (for example, an optical disc) accessed by the image display device 20 possibly stores additional data related to the static or dynamic images. For example, a Music Video DVD may also store miscellaneous data about the Album ID and the track information; a Picture CD optical disc may store numerous JPEG files each associated with its file name and recorded date. When the user desires to capture an image as his favorite logo, they may also want to capture the additional data associated with the image. For this reason, steps 144-158 are included for the operation of reading and storing miscellaneous data. Please refer to the FIG. 12. When the image data 42 of the user's favorite logo is displayed in this embodiment, the image display device 20 reads and displays the miscellaneous data 40 such as the Album ID, file name and so on so that the user can produce a favorite personalized logo.

In step 128, the image display device 20 is capable of determining the quantization level parameter corresponding to different sizes of the image data through a lookup table. The image display device 20 is also capable of applying the same predetermined quantization level parameter to each sizing of the image data.

In steps 130-134, the encoder 24 encodes the image data to generate an encoded image data according to the program code stored in the flash memory 26 and the quantization level parameter corresponding to the image data. Then whether the remaining space is large enough to store the encoded image data is determined. If the remaining space is not large enough to store the encoded image, the quantization level parameter is adjusted to an updated quantization level parameter. Using the updated quantization level parameter, the encoder 24 encodes the image data again to generate another encoded image data. Then, the remaining space available to storing the newly generated encoded image data is checked again. The process of encoding and checking is repeated until there is enough space to store the latest encoded image data.

The flash memory 26 includes a plurality of memory banks. When some of the content stored in the flash memory 26 is unwanted and needs to be erased, the content will be erased by the unit of banks. That is, all content stored in those banks containing unwanted content will be erased. The storage size of each bank varies by different models and different manufacturers of the flash memory. For example the storage size of each bank could be 64 KB in this embodiment.

In steps 136-142, when there is an existing encoded image data in the flash memory 26, the existing encoded image data should be read and stored temporarily in the dynamic memory 34. The encoded image data and the existing encoded image data are kept and the available space in the flash memory 26 is erased and rearranged. The encoded image data and the existing encoded image data are then stored into the flash memory 26. In this way, though the flash memory 26 has previously stored another user's favorite logo, the previously stored user's favorite logo will not be deleted. Rather, both the previously stored user's favorite logo and the newly determined user's favorite logo are kept in the flash memory 26. Therefore, the user can select different user's favorite logos under different conditions. If the flash memory 26 does not store other existing encoded image data representing previously stored user's favorite logo, the available space in the flash memory 26 will be erased, and the encoded image data representing newly determined user's favorite logo will be stored in the flash memory 26.

In steps 144-148, the miscellaneous data related to the plurality of image data and the display parameters of the plurality of image data are read from the storage medium 36 storing the plurality of image data and then stored in the display parameters buffer 283. When the remaining space of the flash memory 26 is large enough to store the encoded image data representing newly determined user's favorite logo, the miscellaneous data related to the storage medium 36 and the display parameters of the image data temporarily stored in the display parameters buffer 283 are transferred to the EEPROM 32. The operation of selecting and storing the newly determined user's favorite logo is finished.

The following are the steps that the image display device 20 uses to read the user's favorite logo when the image display device 20 is started. In steps 150-156, when the image display device 20 is restarted, the encoded image data representing the user's favorite logo is read from the flash memory 26, and the decoder 22 decodes the encoded image data to generate a decoded image data. Additionally, the miscellaneous data and the display parameters of the selected image data are read from the EEPROM 32. Then the decoded image data and the miscellaneous data are displayed on the image display device 20 according to the display parameters of the selected image data. The displaying result is shown in FIG. 12. The sequence of step 152 and step 154 can be altered or these two steps can be performed simultaneously.

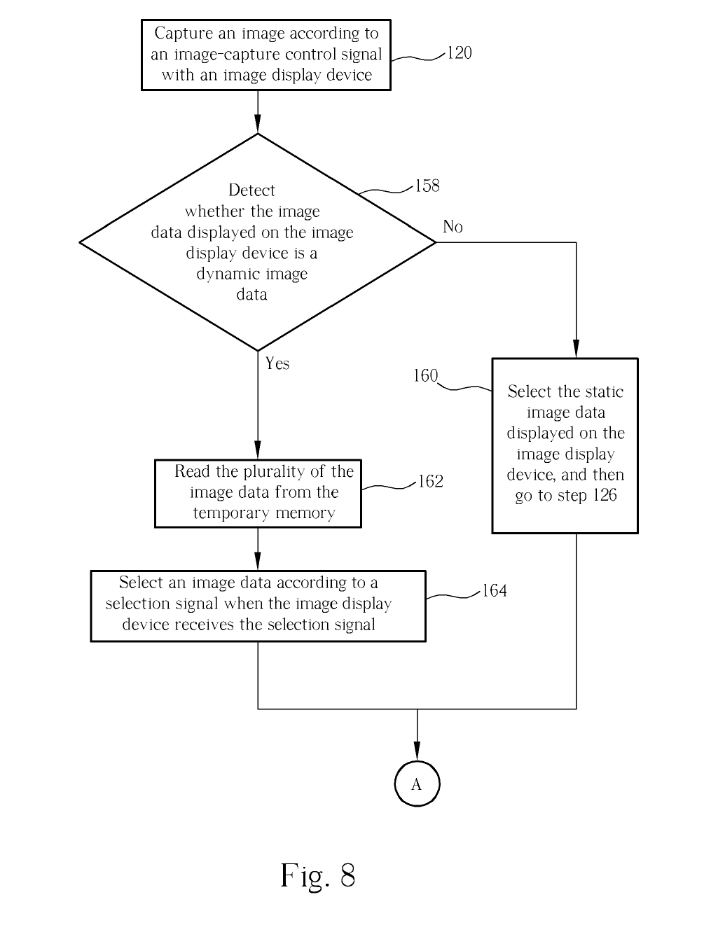

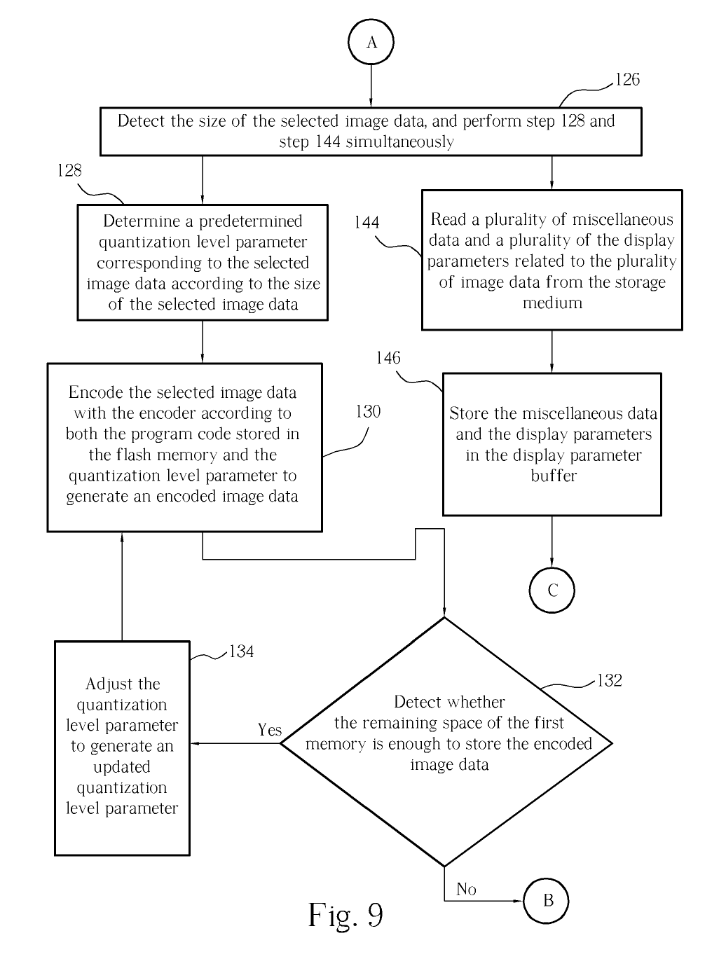

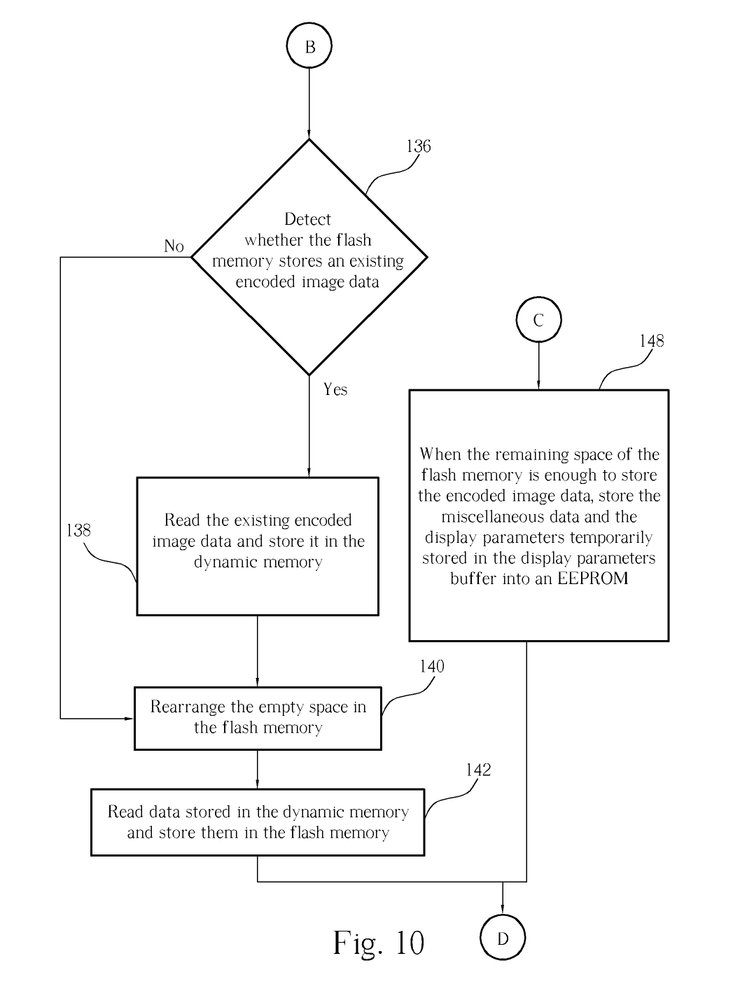

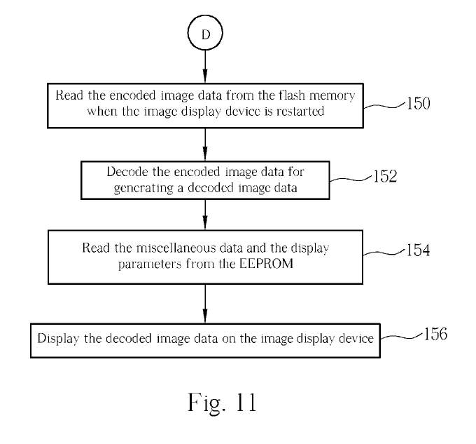

Please refer to FIG. 3 in conjunction with FIG. 8-11. FIG. 8-11 respectively illustrates the first, second, third, and fourth stage of a flowchart of a method for generating a user's favorite logo of an image display device according to the second embodiment. The symbol A is used for connecting FIG. 8 and FIG. 9. The symbol B and the symbol C are used for connecting FIG. 9 and FIG. 10. The symbol D is used for connecting FIG. 10 and FIG. 11. Additionally, the difference between this embodiment and the above-mentioned first embodiment is that the steps 158-164 replace the steps 122-124, with the other steps being the same. The steps 158-164 are described as follows:

Step 158: Detect whether the image data displayed on the image display device 20 is a dynamic image data. If the image data displayed on the image display device 20 is a dynamic image data, go to step 162; otherwise, go to step 160;

Step 160: Select the static image data displayed on the image display device 20, and then go to step 126;

Step 162: Read the plurality of the image data from the temporary memory 28;

Step 164: Select an image data according to a selection signal when the image display device 20 receives the selection signal.

In steps 158-164, when the image display device 20 displays an image data (ex: a static image data or a dynamic image data) and receives an image-capture control signal, the image display device 20 detects the data type of the image data processed by the image display device 20. If the data type of the image data is the dynamic image data type, a plurality of image data temporarily stored in the temporary memory 28 are read and displayed on the user interface. When the image display device 20 receives a selection signal, the image display device 20 selects an image data from the plurality of image data. If the data type of the image data is the static image data type, the static image data is displayed on the user interface. When the image display data receives a selection signal, the static image data is used act as the image data of the user's favorite logo.

In the present invention, the method for generating the user's favorite logo of the image display device in the first embodiment and the second embodiment uses an electrically erasable programmable read only memory (EEPROM) to store the miscellaneous data and the display parameters of the image data. But it is also possible to store the miscellaneous data and the display parameters of the selected image data and the encoded image data of the flash memory 26 in a memory other than in an electrically erasable programmable read only memory (EEPROM) 32.

Compared with the prior art, the advantage of the invention includes: when the user's favorite logo is captured, the image data is directly captured from the plurality of image data stored in a frame buffer of the temporary memory so that most of the system resources will not be greatly consumed.

In the present invention, different kinds of image data that can be displayed on the image display device can be captured by the image display device. And the user can select an image that he likes from a group of sequential images, meaning that the user does not have to worry about timing when trying to capture an image. In the present invention, when the image display device captures and the stores the user's favorite logo, the image display device also captures and stores the associated miscellaneous data (for example, disc data, Album ID, Title, track, file name, etc.) and display parameters (for example, the zoom factor, the color or brightness settings, etc.) so that the goal “What You See Is What You Get” can be achieved.

Those skilled in the art will readily observe that numerous modifications and alterations of the device may be made while retaining the teachings of the invention. Accordingly, the above disclosure should be constructed as limited only by the metes and bounds of the appended claims.

What is claimed is:

1. A method for generating a user's favorite logo of an image display device, the method comprising:
(a) providing a plurality of image data on the image display device;
(b) selecting an image data from the plurality of image data;
(c) encoding the image data selected from the plurality of image data for generating an encoded image data;
(d) storing the encoded image data in a first memory;
(e) decoding the encoded image data from the first memory when the image display device is re-started.
(f) decoding the encoded image data for generating a decoded image data after performing step (e); and
(g) displaying the decoded image data on the image display device.

2. The method of claim 1 wherein the plurality of image data provided in step (a) are captured from a dynamic image file.

3. The method of claim 1 further comprising:
(h) quantizing the image data selected in step (b);
wherein step (c) further comprises encoding the image data quantized in step (h).

4. The method of claim 3 further comprising detecting the size of the image data selected in step (b), and step (h) further comprising quantizing the image data selected in step (b) according to the size of the image data.

5. The method of claim 3 further comprising detecting whether remaining space of the first memory is enough to store the encoded image data; when the remaining space of the first memory is enough to store the encoded image data, performing step (d); and when the remaining space of the first memory is not enough to store the encoded image data, quantizing the selected image data again.

6. The method of claim 1 wherein the first memory is a flash memory.

7. The method of claim 1 further comprising reading an existing image data in the first memory and the encoded image data before performing step (d); wherein step (d) stores the existing image data and the encoded image data back to the first memory.

8. The method of claim 7 further comprising erasing at least part of the first memory before performing step (d).

9. The method of claim 1 further comprising detecting display parameters of the selected image data and storing the display parameters of the selected image data in a second memory.

10. The method of claim 9 further comprising reading the display parameters from the second memory before performing step (g);
wherein step (g) further comprises displaying the decoded image data on the image display device according to the display parameters.

11. The method of claim 9 wherein the second memory is an electrically erasable programmable read only memory (EEPROM).

12. The method of claim 1 further comprising storing miscellaneous data corresponding into the selected image data in a second memory.

13. The method of claim 12 further comprising reading the miscellaneous data from the second memory before performing step (g);
wherein step (g) further comprises displaying the decoded image data on the image display device according to the miscellaneous data.

14. The method of claim 12 wherein the second memory is an electrically erasable programmable read only memory (EEPROM).

15. An image display device for performing the method of claim 1.

16. A method for generating a user's favorite logo of an image display device, the method comprising:
(a) detecting whether a first image data processed by the image display device is captured from a dynamic image file;
(b) providing a plurality of image data from the dynamic image file and selecting an image data from the plurality of the image data to be a selected image data when the first image data is captured from the dynamic image file; and selecting the first image data to be a selected image data when the first image data is not captured from the dynamic image file;
(c) encoding the selected image data to generate an encoded image data;
(d) storing the encoded image data in a first memory;
(e) reading the encoded image data stored in the first memory when the image display device is restarted;
(f) decoding the encoded image data to generate a decoded image data after performing step (e); and
(g) displaying the decoded image data on the image display device.

17. The method of claim 16 further comprising:
(h) quantizing the selected image data of step (b);
wherein step (c) further comprises encoding the selected image data quantized in step (h).

18. The method of claim 17 further comprising detecting the size of the selected image data;
wherein step (h) further comprises quantizing the selected image data of step (b) according to the size of the selected image data.

19. The method of claim 17 further comprising detecting whether remaining space of the first memory is enough to store the encoded image data of step (c); when the remaining space of the first memory is enough to store the encoded image data in step (c), performing step (d); and when the remaining space of the first memory is not enough to store the encoded image data in step (c), quantizing the selected image data again.

20. The method of claim 16 wherein the first memory is a flash memory.

21. The method of claim 16 further comprising reading an existing image data in the first memory and the encoded image data before performing step (d);
wherein step (d) further comprises storing the existing image data and the encoded image data back to the first memory.

22. The method of claim 21 further comprising erasing at least part of the first memory before performing step (d).

23. The method of claim 16 further comprising detecting display parameters of the selected image data and storing the display parameters of the selected image data in a second memory.

24. The method of claim 23 further comprising reading the display parameters from the second memory before performing step (g);
wherein step (g) further comprises displaying the decoded image data on the image display device according to the display parameters.

25. The method of claim 23 wherein the second memory is an electrically erasable programmable read only memory (EEPROM).

26. The method of claim 16 further comprising storing disc data of the selected image data in a second memory.

27. The method of claim 26 further comprising reading the miscellaneous data from the second memory before performing step (g);
wherein step (g) further comprises displaying the decoded image data on the image display device according to the miscellaneous data.

28. The method of claim 26 wherein the second memory is an electrically erasable programmable read only memory (EEPROM).

29. An image display device for performing the method of claim 16.
